(19) United States
(12) Patent Application Publication
(10) Pub. No.: US 2025/0322697 A1
(43) Pub. Date: Oct. 16, 2025

(54) INJECTION ATTACK DETECTION

(71) Applicant: MASHANG CONSUMER FINANCE CO., LTD., Chongqing (CN)

(72) Inventor: Dingheng ZENG, Chongqing (CN)

(21) Appl. No.: 18/964,273

(22) Filed: Nov. 29, 2024

(30) Foreign Application Priority Data
Apr. 10, 2024 (CN) 202410431075.9

(51) Int. Cl. G06V 40/40; G06F 21/52; G06T 7/32; G06V 10/141; G06V 10/56; G06V 10/60; G06V 40/16

(52) U.S. Cl. CPC G06V 40/40; G06F 21/52; G06T 7/32; G06V 10/141; G06V 10/56; G06V 10/60; G06V 40/168; G06F 2221/034; G06T 2207/10016; G06T 2207/10024; G06T 2207/30201

(57) ABSTRACT

In an injection attack detection method, a video is obtained. The video includes a plurality of video frames of a target face illuminated according to a plurality of light values. A grayscale transformation is performed on a video frame of the plurality of video frames of the video to obtain a first grayscale value of the video frame. A light value of the plurality of light values is converted to obtain a second grayscale value correspond to the video frame. The video is subjected to an injection attack that is determined based on the first grayscale value and the second grayscale value.

### RELATED APPLICATION

The present application claims priority to Chinese Patent Application No. 202410431075.9 filed on Apr. 10, 2024. The entire disclosure of the prior application is hereby incorporated by reference.

### FIELD OF THE TECHNOLOGY

The present disclosure relates to the field of image processing technology, including to an injection attack detection method, device, equipment, storage medium and program product.

### BACKGROUND OF THE DISCLOSURE

Identity verification technology based on facial recognition is widely used in the Internet financial scenarios. However, various means of identity forgery are emerging in an endless stream. Among the many means of identity forgery, injection attacks are currently more difficult to detect and prevent.

### SUMMARY

The present disclosure provides an injection attack detection method, a device, an equipment, a non-transitory computer-readable storage medium, and a program product, which are used to implement injection attack detection in a lightweight and low-complexity manner, suitable for local execution on a mobile terminal, and have high security, low resource consumption, and fast response speed.

In an aspect of the present disclosure, an injection attack detection method is provided. In the method, a video that includes a plurality of video frames of a target face illuminated according to a plurality of light values is obtained. A grayscale transformation is performed on a video frame of the video to obtain a first grayscale value of the video frame. A light value of the plurality of light values is converted to obtain a second grayscale value corresponding to the video frame. Whether the video is subjected to an injection attack is determined based on the first grayscale value and the second grayscale value.

In an aspect of the present disclosure, an injection attack detection apparatus, including processing circuitry is provided. The processing circuitry is configured to obtain a video that includes a plurality of video frames of a target face that is illuminated according to a plurality of light values. The processing circuitry is configured to perform a grayscale transformation on a video frame of the video to obtain a first grayscale value of the video frame. The processing circuitry is configured to convert a light value of the plurality of light values to obtain a second grayscale value corresponding to a light attribute applied in the video frame. The processing circuitry is configured to determine whether the video is subjected to the injection attack based on the first grayscale value and the second grayscale value.

An aspect of the present disclosure provides an electronic device, including a processor and a memory for storing instructions executable by the processor. The processor is configured to execute the instructions to implement the injection attack detection method as described in the aspects of this disclosure.

An aspect of the present disclosure provides a non-transitory computer-readable storage medium, storing instructions which when executed by a processor of an electronic device, cause the processor to perform the injection attack detection method as described in the aspects of this disclosure.

At least one of the above technical solutions adopted in the aspects of the present disclosure can achieve the following beneficial effects: Considering that there is a difference between the light changes of the target face in the injected video and the light changes of the target face during the period of irradiating the target face, this difference is more obvious in the grayscale value. During the period of irradiating the target face, the target face is photographed to obtain the video to be detected; by identifying the grayscale values of the video frame in the video to be detected and light shining on the target person's face Whether there is a significant difference in the grayscale values of the video can determine whether the acquired video is subjected to an injection attack. The algorithm logic is simpler, stable, and has a high success rate. The grayscale value comparison is easier than the original pixel value comparison and has the advantage of being lightweight. Therefore, the injection attack detection method provided in the embodiment of the present disclosure can be run in real time on a mobile terminal and is suitable for various scenarios such as computer applications (e.g., APP and H5).

### BRIEF DESCRIPTION OF THE DRAWINGS

The drawings described herein are used to provide a further understanding of the present disclosure and constitute a part of the present disclosure. The illustrative examples of the present disclosure and their descriptions are used to explain the present disclosure and do not constitute an improper limitation on the present disclosure. In the drawings:

FIG. 1 is a flow chart of an injection attack detection method provided by an aspect of the present disclosure;

FIG. 2 is a schematic diagram of an online face recognition process provided by an aspect of the present disclosure;

FIG. 3 is a flow chart of an injection attack detection method provided by an aspect of the present disclosure;

FIG. 4 is a schematic diagram of the structure of an injection attack detection device provided by an aspect of the present disclosure;

FIG. 5 is a schematic diagram of the structure of an electronic device provided by an aspect of the present disclosure.

### DETAILED DESCRIPTION

Examples of technical solutions and advantages of the present disclosure will be described below in combination with aspects of the present disclosure and the corresponding drawings. The described aspects are only part of the present disclosure, not all of the aspects. Based on the aspects in the present disclosure, other examples fall within the scope of protection of this disclosure.

The terms “first,” “second,” etc., in this disclosure and claims are used to distinguish similar objects and are not used to describe a particular order or priority. It should be understood that the terms used in this way are interchangeable where appropriate, so that the aspects of the present disclosure can be implemented in an order other than those illustrated or described herein. In addition, “and/or” in this specification and claims means at least one of the connected objects. The objects before and after the character “/” are in an “and” or an “or” relationship. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Among the many means of identity fraud, injection attacks are currently more difficult to detect and prevent. Although colorful liveness detection using sequence verification has been a good defense against injection attacks, the design of most injection attack algorithms currently requires high computing power and requires the video collected by the front end to be transmitted back to the server for processing. In this way, the injection attack detection process can consume a lot of resources, can have high requirements for the network environment, and security and efficiency can be difficult to guarantee.

A large number of videos that have been subjected to injection attacks were examined and it was found that during the period of irradiating light to the object to be detected, there are differences between the light changes presented by the target face in the video subjected to injection attack and the light changes irradiating the target face, and this difference is more obvious in grayscale.

Based on this, the aspect of the present disclosure proposes a lightweight injection attack detection method, taking into account that during the period of irradiating light to the target face, there is a difference between the light changes presented by the target face in the video subjected to the injection attack and the light changes irradiating the target face, and this difference is more obvious in grayscale. During the period of irradiating light to the target face, the target face is captured (e.g., photographed or recorded) to obtain the video to be detected; by identifying whether there is a significant difference between the grayscale values of the video frame in the video to be detected and the grayscale values of the light irradiating the target face, it can be determined whether the acquired video is subjected to an injection attack. The algorithm logic is simpler, stable, and has a high success rate. The comparison of grayscale values is easier than the comparison of original pixel values and has the advantage of being lightweight. Therefore, the injection attack detection method provided in the aspect of the present disclosure can be run in real time on a mobile terminal and is suitable for various scenarios such as APP and H5.

In addition, in order to enhance the defense capability against injection attacks, a large amount of random space can be generated by randomly combining the RGB value, brightness, and exposure time of the light irradiating the target face, making it difficult for attackers to implement injection attacks through enumeration.

The injection attack detection method provided in the aspect of the present disclosure can be applied to various business scenarios with injection attack detection needs. For example, in a remote identity authentication scenario, after the video to be detected is detected using the injection attack detection method provided in the aspect of the present disclosure, the identity information of the object to be detected is confirmed according to the injection attack detection result. For another example, in an access control scenario, after the video to be detected is detected using the injection attack detection method provided in the aspect of the present disclosure, whether the object to be detected is allowed to enter a specific area is confirmed according to the injection attack detection result. In another example, in a face-swiping payment scenario, after the video to be detected is detected using the injection attack detection method provided in the aspect of the present disclosure, whether to provide payment services is determined according to the injection attack detection result.

It should be understood that the injection attack detection method provided in the aspect of the present disclosure may be applied to business scenarios such as remote identity authentication, access control, and face payment. It is only an example description and should not be understood as a limitation on the disclosure scenarios of the injection attack detection method.

The injection attack detection method provided in the aspect of the present disclosure can be executed by an electronic device, such as by a processor of the electronic device. The electronic device here may include a terminal device, such as but not limited to a smart phone, a tablet computer, a laptop computer, a desktop computer, an intelligent voice interaction device, a smart home appliance, a smart watch, a vehicle terminal, an aircraft, etc.; or, the electronic device may also include a server, such as an independent physical server, or a server cluster or distributed system composed of multiple physical servers, or a cloud server providing cloud computing services.

Technical solutions provided by various aspects of the present disclosure are described in further detail below in conjunction with the accompanying drawings.

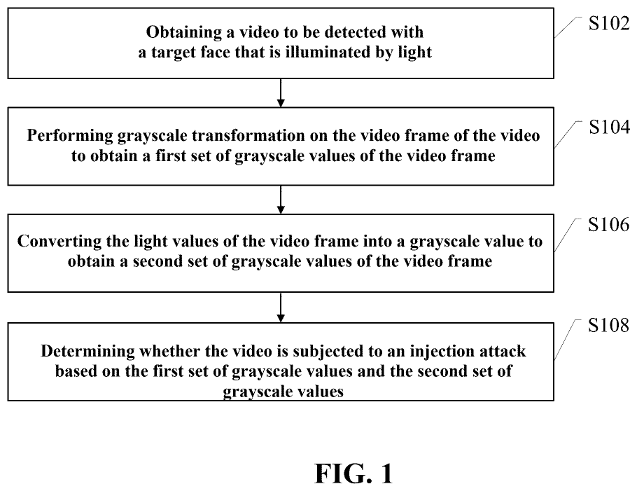

FIG. 1 is a flow chart of an injection attack detection method provided by an aspect of the present disclosure. The method may include the following steps:

S102: Obtaining a video to be detected with a target face that is illuminated by light.

The video to be detected is obtained by collecting images of the target face under light irradiation. The video frame of the video to be detected contains the target face.

The light irradiating the target face includes a plurality of light rays arranged in sequence. Each light ray has corresponding attributes. Among them, the attributes of the light ray include at least a color attribute, and the color attribute represents the RGB (Red, Green, and Blue) value of the light ray for example. Since the absorption characteristics and polarization effects of the same light ray are different for the real face and the counterfeit face, by irradiating the target face with light rays of different RGB values, collecting videos of the target face under different light irradiation, and comparing the RGB value changes of the light irradiating the target face with the RGB value changes presented in the video, it is possible to accurately determine whether the target face is a counterfeit face, that is, whether the collected video is subject to an injection attack. The injection attack detection process does not require the user to cooperate with the corresponding actions and is simpler to implement and more efficient.

In an example, the RGB values of the multiple lights can be set according to actual business needs, and the aspects of the present disclosure do not limit this. In one aspect, the method for generating the light irradiating the target face includes: randomly selecting multiple RGB values from the RGB value range and combining them to obtain a target RGB value sequence; based on the target RGB value sequence, irradiating the target face with light. In this method, since the multiple RGB values are randomly selected and combined, the target RGB value sequence obtained by the combination has a certain degree of randomness, which can increase the difficulty of the light irradiating the target face to be enumerated by the attacker, thereby enhancing the defense against injection attacks.

In an example, irradiating light to the target face can be achieved in various ways. As an example, the screen of the terminal device can be used to emit light according to the target RGB value sequence, which is simpler to implement and does not require the use of an external light source device, thereby reducing the implementation cost of the method. As another example, an external light source device can also be used to control the external light source device to emit light according to the target RGB value sequence to form light irradiating the target face.

Secondly, randomly selecting multiple RGB values from the RGB value range for combination can be achieved in various ways. As an example, randomly selecting multiple RGB values from the RGB value range for combination includes: selecting a maximum RGB value and a minimum RGB value from the RGB value range, and randomly selecting at least one target RGB value from the RGB value range, wherein the R component, G component, and B component of the target RGB value are the same, and the target RGB value is between the maximum RGB value and the minimum RGB value; combining the maximum RGB value, the minimum RGB value, and at least one target RGB value to obtain a target RGB value sequence.

For example, at least one target RGB value includes a target RGB value representing light gray and a target RGB value representing dark gray, the maximum RGB value represents white, and the minimum RGB value represents black. The maximum RGB value, the minimum RGB value, and the two target RGB values are randomly combined to obtain a target RGB value sequence. Since the class spacing between black, white, and grayscale colors is small and difficult to distinguish, by combining the RGB values representing these colors, the difficulty of enumerating the target RGB value sequence can be further increased, and the defense against injection attacks can be further enhanced; and by randomly combining these RGB values, the randomness of the target RGB value sequence is further increased, and the difficulty of enumerating the target RGB value sequence is further increased.

In another example, at least one target RGB value includes target RGB values corresponding to various grays, and these target RGB values are randomly combined to obtain a candidate RGB value sequence; then, the minimum RGB value representing black is added before the first RGB value in the candidate RGB value sequence, and the maximum RGB value representing white is added after the last RGB value in the candidate RGB value sequence to obtain a target RGB value sequence. In this combination method, on the one hand, the class spacing between black, white and grayscale colors is small and difficult to distinguish. By combining the RGB values representing these colors, the difficulty of enumerating the target RGB value sequence can be further increased, and the defense against injection attacks can be further enhanced; on the other hand, the light generated based on the target RGB value sequence starts with black light and ends with white light, so that the imaging of the target face in the collected video to be detected presents a regularity of sequence start and end, which helps to improve the accuracy of injection attack detection.

In another aspect, in order to determine the number of random spaces formed by the combination of multiple light rays, the light attribute may also include non-color attributes, which may specifically include, but are not limited to, at least one of the following attributes: brightness, exposure time. In this case, based on the target RGB value sequence, irradiating the target face with light comprises the following steps: randomly selecting multiple attribute values from the value range of the non-color attribute to combine and obtain a non-color attribute sequence; based on the target RGB value sequence and the non-color attribute sequence, irradiating the target face with light.

As an example, non-color attributes include brightness and exposure duration. In this case, multiple brightness values are randomly selected from the brightness value range to obtain a brightness value sequence. Multiple durations are randomly selected from the duration value range to obtain a duration sequence. Based on the target RGB value sequence, the brightness value sequence and the duration sequence, light is irradiated to the target face.

For example, the multiple light rays include light 1 to light 4, the target RGB value sequence is {minimum RGB value for black, target RGB value 1 for light gray, target RGB value 2 for dark gray, maximum RGB value for white}, the brightness value sequence is {brightness 1, brightness 2, brightness 3, brightness 4}, and the duration sequence is {300 ms, 500 ms, 800 ms, 1000 ms}. In this case, the screen of the terminal device is controlled to continuously emit light with the minimum RGB value and brightness 1; after continuous irradiation for 300 ms, the screen is controlled to continuously emit light with the target RGB value 1 and brightness 2; after continuous irradiation for 500 ms, the screen is controlled to continuously emit light with the target RGB value 2 and brightness 3; after continuous irradiation for 800 ms, the screen is controlled to continuously emit light with the maximum RGB value and brightness 4; after continuous irradiation for 1000 ms, the screen is controlled to stop emitting light. While the target face is irradiated by the above-mentioned multiple light rays, the camera of the terminal device is synchronously controlled to collect images of the target face to obtain the video to be detected.

In an aspect, at least one of the illumination parameters such as corresponding brightness and illumination duration is configured for multiple lights, so that multiple RGB values, multiple brightnesses and multiple illumination durations can be randomly combined, thereby significantly increasing the number of random spaces, thereby increasing the randomness of finding the target face of the light, and increasing the difficulty of enumerating the light by the attacker, thereby enhancing the defense against injection attacks.

S104: Performing grayscale transformation on the video frame of the video to obtain a first set of grayscale values of the video frame.

In an example, for each video frame of the video to be detected, the video frame can be converted into a corresponding grayscale image by performing grayscale transformation on the video frame, and then the first grayscale value of the video frame can be determined through the grayscale values of the grayscale image.

In an aspect, S104 includes the following steps: step A1, based on the pixel values of the pixels of the video frame, determining the key facial area in the video frame that meets the preset pixel distribution conditions; step A2, performing grayscale transformation on the key facial area to obtain a first grayscale image; step A3, determining the grayscale mean of the first grayscale image as the first grayscale value of the video frame.

Among them, the preset pixel distribution conditions can be set according to actual needs, and the aspects of the present disclosure do not limit this. As an example, considering that the color presented by the image area with uniform pixel distribution in the video frame is more obvious and easier to compare and analyze, it is helpful to improve the detection accuracy by performing grayscale transformation on such areas and then identifying injection attacks. Based on this, the preset pixel distribution conditions may include uniform pixel distribution, etc. In practical disclosures, whether the pixel distribution is uniform can be achieved through various pixel analysis algorithms commonly used in the field.

The key facial area can be set according to actual needs, and the aspects of the present disclosure do not limit this. As an example, considering that under the same light, the difference between the RGB values of the fake face in the nose, cheeks, and other areas and the RGB values of the light is more obvious, by analyzing the RGB values of these areas and the RGB values of the light, it is helpful to improve the accuracy of injection attack detection. Based on this, the key facial area can include the nose, cheeks, and other areas in the video frame.

For example, firstly, the video frame is analyzed for facial key points to obtain the nose key points and the cheek key points; then, based on the nose key points and the cheek key points, the facial area including the nose and the cheek is cut out from the video frame; then, based on the pixel values of the pixels in the facial area, an area with uniform pixel distribution is further cut out from the facial area to obtain the facial key area; finally, after performing grayscale transformation on the facial key area, the grayscale value mean of the pixels of the first grayscale image is calculated, that is, the grayscale mean of the first grayscale image, and the grayscale mean is used as the first grayscale value of the video frame.

In an example, since the key facial areas in the video frame that meet the pixel distribution conditions are not only more obvious in the presented RGB values and easier to compare and analyze, but also can clearly distinguish real faces from counterfeit faces, by performing grayscale transformation on such key facial areas and then determining the grayscale mean, the obtained first grayscale value can more clearly distinguish real faces from counterfeit faces, which helps to improve detection accuracy.

In an aspect, S104 includes the following steps: step B1, determining the irradiation direction of the light irradiating the target face; step B2, determining the imaging shadow area of the target face in the video frame based on the irradiation direction; step B3, performing grayscale transformation on the imaging shadow area to obtain a second grayscale image; step B4, determining the grayscale mean of the second grayscale image as the first grayscale value of the video frame.

In an example, each light beam irradiating the target face may have different irradiation directions, which can be selected according to actual needs. By irradiating the target face with light beams in different irradiation directions, the collected video frames contain certain depth information, which helps to accurately distinguish between real faces and counterfeit faces.

The imaging shadow area refers to the area where the protruding parts of the target face leave shadows. Under the illumination of light from different illumination directions, the imaging shadow area of the target face in the video frame is different. For example, when the target face is illuminated by light from the left side, the protruding parts such as the nose, mouth and eyebrows will leave shadows on the right side of the face, and the imaging shadow area is the right area of the video frame; when the target face is illuminated by light from the right side, the protruding parts such as the nose, mouth and eyebrows will leave shadows on the left side of the face, and the imaging shadow area is the left area of the video frame; when the target face is illuminated by light from the upper side, the protruding parts such as the eyebrows and nose will leave shadows on the upper side of the face, and the imaging shadow area is the upper area of the video frame; when the target face is illuminated by light from the lower side, the protruding parts such as the mouth and nose will leave shadows on the lower side of the face, and the imaging shadow area is the upper area of the video frame.

In this aspect, since the image features of the imaging shadow area are relatively obvious and stable, it can reflect the depth information of the face to a certain extent, and there is a significant difference in depth information between the real face and the counterfeit face. By performing grayscale transformation on the imaging shadow area in the video frame and determining the grayscale mean, the obtained second grayscale value can more clearly distinguish the real face from the counterfeit face, which helps to improve the detection accuracy.

The aspect of the present disclosure shows some methods of S104. Of course, it should be understood that S104 can also be performed in other ways, such as performing grayscale transformation on the entire video frame to obtain a third grayscale image, and determining the grayscale mean value of the third grayscale image as the first grayscale value of the video frame, etc., and the aspect of the present disclosure does not limit this.

S106: Converting the light values of the video frame into a grayscale value to obtain a second set of grayscale values of the video frame.

Each video frame in the video to be detected has a corresponding light values. The light values represent the properties of the light irradiating the target face when shooting the video frame, such as but not limited to the RGB value, brightness, etc. of the light. In one aspect, there is a first corresponding relationship between the RGB value of the light and the grayscale value, and there is a second corresponding relationship between the brightness of the light and the grayscale value. For example, the grayscale value corresponding to the RGB value representing light green is 200, the grayscale value corresponding to the RGB value representing dark green is 80, the grayscale value corresponding to the RGB value representing dark blue is 60, the grayscale value corresponding to the low brightness is 30, the grayscale value corresponding to the moderate brightness is 50, the grayscale value corresponding to the high brightness is 90, and so on.

In this case, for each video frame, based on the first correspondence and the RGB value indicated by the light value label (or light values) of the video frame, the RGB value indicated by the light value label is converted into a corresponding grayscale value, and based on the second correspondence and the brightness indicated by the light value label of the video frame, the brightness indicated by the light value label is converted into a corresponding grayscale value; then, a weighted sum is performed on the two grayscale values to obtain a second grayscale value of the video frame.

In an example, when the brightness of each light can be controlled, such as in the APP usage scenario, the light value label of the video frame contains RGB value and brightness. In this case, the RGB value of the light can be converted to Hue Saturation Value (HSV) color value, and the value of the V component in the HSV color value is used as the brightness in the light value label. When the brightness of each light cannot be controlled, such as in the H5 page usage scenario, the brightness of the light cannot be obtained directly. In this case, the RGB value of the light can be converted to HSV color value, and the product of the V component in the HSV color value and the preset brightness coefficient is used as the brightness in the light value label. Among them, the preset brightness coefficient can be set according to actual needs, for example, the brightness coefficient is 0.3 when the light is dim, the brightness coefficient is 0.5 when the light is normal, and the brightness coefficient is 0.9 when the light is bright.

S108: Determine whether the video is subjected to an injection attack based on the first set of grayscale values and the second set of grayscale values.

Considering that during the period of irradiating light to the target face, the RGB value of the target face in the video under injection attack is different from the RGB value of the light, and this difference is more obvious in the grayscale value, by identifying whether there is a significant difference between the grayscale value of the target face in the video to be detected and the grayscale value of the light, it can be determined whether the collected video is under injection attack. The algorithm has simpler logic, good stability, high success rate, and the comparison of grayscale values is easier than the comparison of original pixel values, which has the advantage of being lightweight.

In one aspect, S108 includes the following steps: Step C1, for each video frame in the video to be detected, matching the first grayscale value and the second grayscale value of the video frame to obtain the matching degree between the two; Step C2, if the matching degree between the first grayscale value and the second grayscale value of the video frames exceeding a preset ratio in the video to be detected is less than the preset matching degree, then it is determined that the light changes presented by the target face in the video to be detected are inconsistent with the light changes irradiating the target face, and then it is determined that the video to be detected is subjected to an injection attack. Conversely, if the matching degree between the first grayscale value and the second grayscale value of the video frames exceeding a preset ratio in the video to be detected is greater than or equal to the preset matching degree, then it is determined that the light changes presented by the target face in the video to be detected are consistent with the light changes irradiating the target face, and then it is determined that the video to be detected is a real face video.

In another aspect, S108 includes the following steps: step D1, generating a first grayscale value sequence of the video to be detected based on the first grayscale value of the video frame in the video to be detected; step D2, generating a second grayscale value sequence of the video to be detected based on the second grayscale value of the video frame in the video to be detected; step D3, performing correlation analysis on the first grayscale value sequence and the second grayscale value sequence to obtain a first coefficient; step D4, if the first coefficient is less than a preset coefficient, determining that the video to be detected is subjected to an injection attack.

In an example, correlation analysis can adopt various correlation analysis algorithms commonly used in the art, such as Pearson correlation analysis, etc., which are not limited in the aspects of the present disclosure. If the first coefficient between the first gray value sequence and the second gray value sequence is larger, it indicates that the consistency between the light changes presented by the target face in the video to be detected and the light changes illuminating the target face is higher, and the possibility that the video to be detected is a real face video is greater; if the first coefficient between the first gray value sequence and the second gray value sequence is smaller, it indicates that the consistency between the light changes presented by the target face in the video to be detected and the light changes illuminating the target face is lower, and the possibility that the video to be detected is a real face video is smaller, and it is more likely to be a video injected by the camera being hijacked (such as an image that is considered to be edited or forged).

For example, the first grayscale values of the video frames in the video to be detected are combined according to the time sequence of the video frames to obtain a first grayscale value sequence, and the second grayscale values of the video frames in the video to be detected are combined according to the time sequence of the video frames to obtain a second grayscale value sequence. Then, the first coefficient between the first grayscale value sequence and the second grayscale value sequence is calculated by the Pearson correlation analysis method. If the first coefficient is greater than or equal to the preset coefficient, it indicates that the light changes presented by the target face in the video to be detected are consistent with the light changes irradiating the target face, and then the video to be detected is determined to be a real face video; if the first coefficient is less than the preset coefficient, it indicates that the light changes presented by the target face in the video to be detected are inconsistent with the light changes irradiating the target face, and then it is determined that the video to be detected is subject to an injection attack.

In this aspect, by performing correlation analysis on the gray value sequence of the video to be detected as a whole, the consistency between the light changes presented by the target face in the video to be detected and the light changes illuminating the target face can be quickly and accurately identified, thereby quickly and accurately identifying whether the video to be detected is subject to injection attack. The algorithm has simpler logic, good stability, high success rate, and correlation analysis based on the gray value sequence is relatively easy, which has the advantage of being lightweight.

In an aspect, considering that the acquisition time of the video to be detected has a certain delay relative to the generation time of the light, for example, after the light source is controlled to emit light, the process of the sensor of the terminal device collecting light and collecting video is a physical process, which specifically includes sensor photosensitization, data processing and conversion, etc. This process is time-consuming, which leads to a delay in the generation time of the light relative to the acquisition time of the video to be detected. This delay may cause a large misalignment between the two gray value sequences, which may cause the two originally related gray value sequences to become unrelated, and thus the detection result is inaccurate.

To this end, in step D3, the interval duration between the acquisition time of the video to be detected and the generation time of the light is obtained; based on the interval duration, the first gray value sequence and the second gray value sequence are aligned; the first gray value sequence and the second gray value sequence after the alignment are subjected to correlation analysis to obtain a first coefficient.

As an example, the first gray value sequence and the second gray value sequence are normalized respectively; then, based on the above-mentioned interval duration, the normalized first gray value sequence is left-shifted by several bits relative to the normalized second gray value sequence, so that the two gray value sequences remain consistent at the moment, thereby achieving alignment between the two; finally, a correlation analysis is performed on the aligned first gray value sequence and the second gray value sequence to obtain a first coefficient.

For example, the two grayscale value sequences before alignment are as follows:
The first gray value sequence: 0010233240001
Second gray value sequence: 10233240001

By shifting the first gray value sequence left by two bits, two gray value sequences can be obtained as follows:
The first gray value sequence after left shift: 10233240001
Second gray value sequence: 10233240001

Therefore, by shifting the first gray value sequence to the left by a certain number of bits, the two can be aligned;

Alternatively, the second gray value sequence can be shifted right by two bits to obtain two gray value sequences as follows:
The first gray value sequence: 0010233240001
Second gray value sequence: 0010233240001

Therefore, by shifting the second gray value sequence right by several bits, the two can be aligned.

In this aspect, by aligning the first gray value sequence and the second gray value sequence and then performing correlation analysis, it is possible to avoid the delay in the acquisition time of the video to be detected relative to the generation time of the light from affecting the injection attack detection result, thereby improving the detection accuracy.

The injection attack detection method provided by one or more aspects of the present disclosure takes into account that during the period of irradiating light to the target face, there is a difference between the light changes presented by the target face in the video subjected to the injection attack and the light changes irradiating the target face, and this difference is more obvious in the grayscale value. During the period of irradiating light to the target face, the target face is photographed to obtain the video to be detected; by identifying whether there is a significant difference between the grayscale value of the video frame in the video to be detected and the grayscale value of the light irradiating the target face, it can be determined whether the acquired video is subjected to an injection attack. The algorithm logic is simpler, stable, and has a high success rate. The comparison of grayscale values is easier than the comparison of original pixel values and has the advantage of being lightweight. Therefore, the injection attack detection method provided by the aspects of the present disclosure can be run in real time on a mobile terminal and is suitable for various scenarios such as APP and H5.

The injection attack detection algorithm provided in the aspect of the present disclosure can be used in the liveness detection link of the online face recognition system. As a sub-link of anti-injection attack, it can be combined with other liveness verification technologies, such as face quality verification technology, motion liveness/silent liveness detection technology, etc., to achieve the best anti-counterfeiting effect.

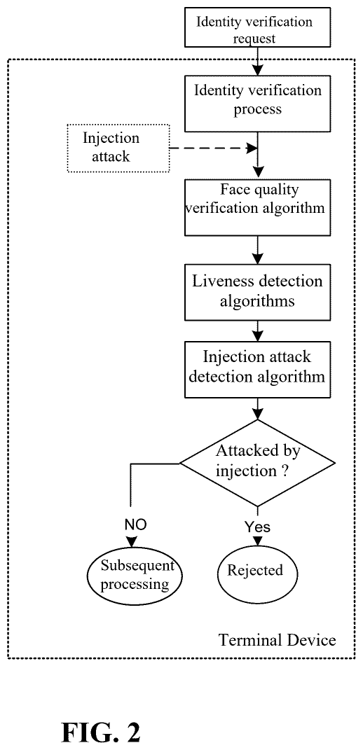

As shown in FIG. 2, the terminal device responds to the user's identity verification request and enters the identity verification process. In the identity verification process, the face quality verification algorithm is first used to verify the quality of the face image taken by the camera of the terminal device, including but not limited to face posture detection, distance detection, ambient light detection, etc., and if the detection result does not meet the requirements, the user is immediately prompted to make adjustments. For example, when it is detected that the face is too far from the screen of the terminal device, the user is prompted to move closer to ensure that the light intensity is sufficient for the face.

Next, liveness detection algorithms are used to perform liveness detection on faces to intercept presentation attacks, such as electronic screen impersonation of faces, paper photos, paper masks, 3D masks, etc.

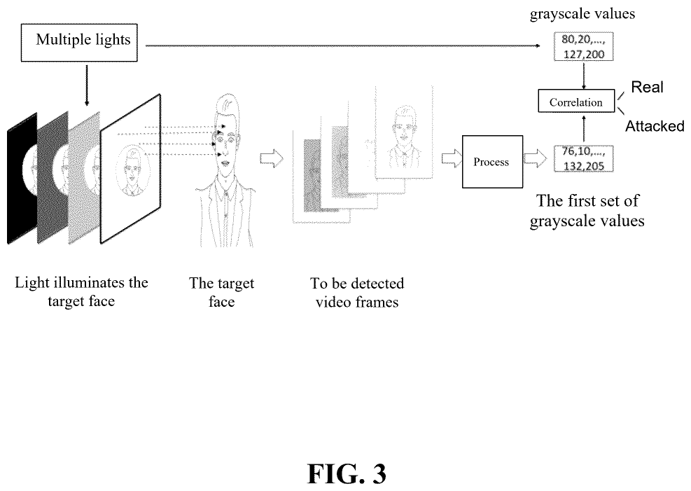

After the liveness detection verification is passed, the injection attack detection algorithm provided in the aspect of the present disclosure is used to detect whether the video to be detected captured by the camera is subjected to an injection attack. As shown in FIG. 3, first, the RGB values, brightness, and irradiation duration of various light rays are randomly configured. Then, the screen of the terminal device is controlled to emit light according to the configured attributes to form a variety of light rays and illuminate the target face. At the same time, the camera is controlled to perform image acquisition on the target face to obtain the video to be detected. Further, the injection attack detection algorithm provided in the aspect of the present disclosure is used to perform grayscale transformation on the video frame of the video to be detected, and the first grayscale value of each video frame is obtained to form a first grayscale value sequence; and the light value label of the video frame is converted into a grayscale value to obtain the second grayscale value of the video frame to form a second grayscale value sequence. Finally, by calculating the correlation analysis of the first grayscale value sequence and the second grayscale value sequence, it is possible to determine whether the video to be detected is subjected to an injection attack based on the first grayscale value and the second grayscale value of each video frame in the video to be detected.

If the video to be detected is attacked by injection, the subsequent processing of the video to be detected is rejected and an identity verification failure message is output. If the video to be detected is a real face video, that is, it has not been attacked by injection, an identity verification success message is output and subsequent processing is performed on the video to be detected.

The above is a description of a specific aspect of the present specification. Other aspects are within the scope of the appended claims. In some cases, the actions or steps can be performed in an order different from that in the aspects and still achieve the desired results. In addition, the processes depicted in the accompanying drawings do not necessarily require the specific order or continuous order shown to achieve the desired results. In some aspects, multitasking and parallel processing are also possible or may be advantageous.

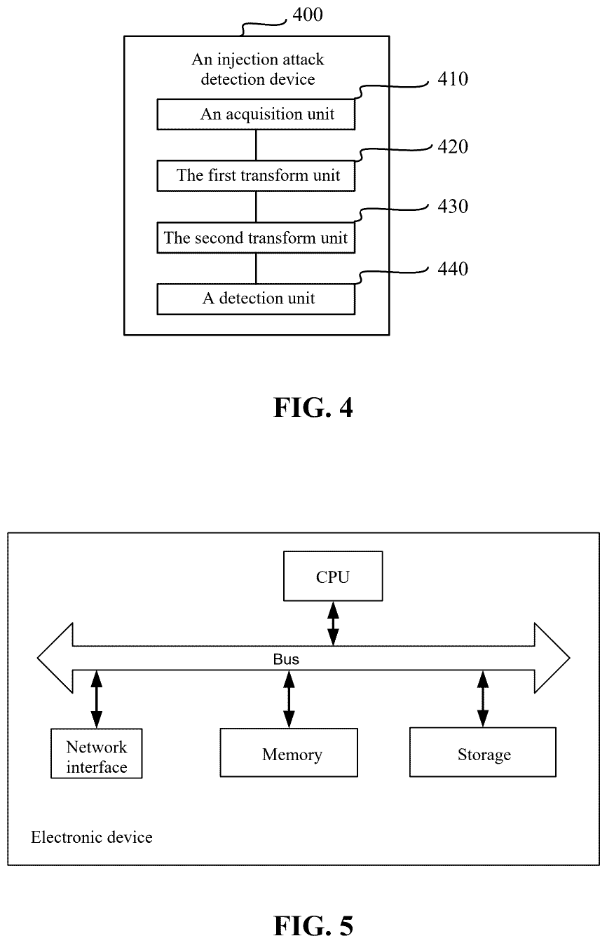

An aspect of the present disclosure also provides an injection attack detection device. FIG. 4 is a schematic diagram of the structure of an injection attack detection device 400 provided in an aspect of the present disclosure, and the device 400 includes: an acquisition unit 410, a first transformation unit 420, a second transformation unit 430 and a detection unit 440.

The acquisition unit 410 is used to acquire a video to be detected that uses light to illuminate the target face.

The first transformation unit 420 is configured to perform grayscale transformation on the video frame of the video to be detected to obtain a first grayscale value of the video frame.

The second transformation/conversion unit 430 is configured to convert the light value label of the video frame into a gray value to obtain a second gray value of the video frame.

The detection unit 440 is configured to determine whether the video to be detected is subjected to an injection attack based on the first grayscale value and the second grayscale value.

In an aspect, the first transform unit 420 is configured to: determine a key facial area in the video frame that satisfies a preset pixel distribution condition based on pixel values of pixels in the video frame; and perform grayscale transformation on the key facial area to obtain a first grayscale image. The grayscale mean value of the first grayscale image is determined as the first grayscale value of the video frame.

In an aspect, the first transform unit 420 is configured to: determine the irradiation direction of the light irradiating the target face; based on the illumination direction, determine an imaging shadow area of the target face in the video frame; and perform grayscale transformation on the imaging shadow area to obtain a second grayscale image. The grayscale mean value of the second grayscale image is determined as the first grayscale value of the video frame.

In an aspect, the detection unit 440 is configured to: based on the first grayscale value of the video frame in the video to be detected, generate a first grayscale value sequence of the video to be detected; based on the second grayscale value of the video frame in the video to be detected, generate a second grayscale value sequence of the video to be detected; and perform correlation analysis on the first gray value sequence and the second gray value sequence to obtain a first coefficient. If the first coefficient is less than the preset coefficient, it is determined that the video to be detected is subjected to an injection attack.

In an aspect, when the detection unit 440 performs correlation analysis on the first gray value sequence and the second gray value sequence to obtain the first coefficient, the detection unit 440 performs the following steps:
Obtaining the interval between the acquisition time of the video to be detected and the generation time of the light;
Based on the interval duration, aligning the first gray value sequence and the second gray value sequence;
A correlation analysis is performed on the first gray value sequence and the second gray value sequence after the alignment process to obtain a first coefficient.

In an aspect, the attribute of the light includes a color attribute, the color attribute represents an RGB value of the light, and the method of generating the light irradiating the target face includes:
Randomly select multiple RBG values from the RGB value range and combine them to obtain the target RBG value sequence;
Based on the target RBG value sequence, light is irradiated toward the target face.

In an aspect, the randomly selecting multiple RGB values from the RGB value range and combining them to obtain a target RGB value sequence includes:
Selecting a maximum RGB value and a minimum RGB value from the RGB value range, and randomly selecting at least one target RGB value from the RGB value range. The R component, the G component, and the B component of the target RGB value are the same, and the target RGB value is between the maximum RGB value and the minimum RGB value;
The maximum RGB value, the minimum RGB value, and the at least one target RGB value are combined to obtain the target RGB value sequence.

In an aspect, the properties of the light further include non-color properties;
The irradiating light to the target face based on the target RGB value sequence includes:
Randomly selecting multiple attribute values from the value range of the non-color attribute and combining them to obtain a non-color attribute sequence;
Based on the target RGB value sequence and the non-color attribute sequence, light is irradiated toward the target face.

The injection attack detection device provided in the aspect of the present disclosure can serve as the execution subject of the injection attack detection method shown in FIG. 1. For example, in the injection attack detection method shown in FIG. 1, step S102 can be executed by the acquisition unit 410 in the injection attack detection device shown in FIG. 4, step S104 can be executed by the first transformation unit 420 in the injection attack detection device shown in FIG. 4, step S106 can be executed by the second transformation unit 430 in the injection attack detection device shown in FIG. 4, and step S108 can be executed by the detection unit 440 in the injection attack detection device shown in FIG. 4.

According to an aspect of the present disclosure, the various units in the injection attack detection device shown in FIG. 4 can be separately or completely combined into one or several other units to constitute, or one (some) of the units can be further divided into multiple functionally smaller units to constitute, which can achieve the same operation without affecting the realization of the technical effects of the aspects of the present disclosure. The above-mentioned units are divided based on logical functions. For example, the functions of one unit can also be implemented by multiple units, or the functions of multiple units can be implemented by one unit. In the aspect of the present disclosure, the injection attack detection device may also include other units. For example, these functions can also be implemented with the assistance of other units and can be implemented by the collaboration of multiple units.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

According to an aspect of the present disclosure, the injection attack detection device shown in FIG. 4 can be constructed, and the injection attack detection method of the aspect of the present disclosure can be implemented by running a computer program (including program code) capable of executing each step involved in the corresponding method shown in FIG. 1 on a general computing device such as a computer including a central processing unit (CPU), a random access memory (RAM), a read-only memory (ROM) and other processing elements and storage elements. The computer program can be recorded on, for example, a computer-readable storage medium, and reproduced in an electronic device through a computer-readable storage medium and run therein.

FIG. 5 is a schematic diagram of the structure of an electronic device of an aspect of the present disclosure. At the hardware level, the electronic device includes a processor (e.g., CPU), and also includes an internal bus, a network interface, and a memory. Among them, the memory may include a memory, such as a non-transitory computer-readable storage medium, a high-speed random access memory (RAM), and may also include a non-volatile memory (non-volatile memory), such as at least one disk storage, etc. Of course, the electronic device may also include hardware required for other services.

The processor, the network interface and the memory may be interconnected via an internal bus, which may be an ISA (Industry Standard Architecture) bus, a PCI (Peripheral Component Interconnect) bus or an EISA (Extended Industry Standard Architecture) bus, etc. The bus may be divided into an address bus, a data bus, a control bus, etc. For ease of representation, FIG. 5 only uses one bidirectional arrow, but does not mean that there is only one bus or one type of bus.

The memory is used to store the program. Specifically, the program may include a program code, and the program code includes a computer operation instruction. The memory may include a memory and a non-volatile memory and provides instructions and data to the processor.

Processing circuitry, such as the processor, reads the corresponding computer program from the non-volatile memory into the memory and then runs it, forming an injection attack detection device at the logical level. The processor executes the program stored in the memory and is specifically used to perform the following operations:
Obtain a video to be detected that illuminates the target face with light;
Performing grayscale transformation on a video frame of the video to be detected to obtain a first grayscale value of the video frame;
Converting the light value label of the video frame into a gray value to obtain a second gray value of the video frame;
Based on the first grayscale value and the second grayscale value, it is determined whether the video to be detected is subjected to an injection attack.

The method performed by the injection attack detection device disclosed in the aspect shown in FIG. 1 of the present disclosure can be applied to a processor or implemented by a processor. The processor may be an integrated circuit chip with signal processing capabilities. In the implementation process, each step of the above method can be completed by an integrated logic circuit of hardware in the processor or instructions in software form. The above processor can be a general-purpose processor, including a central processing unit (CPU), a network processor (NP), etc.; it can also be a digital signal processor (DSP), an disclosure-specific integrated circuit (ASIC), a field-programmable gate array (FPGA) or other programmable logic devices, discrete gates or transistor logic devices, discrete hardware components. The methods, steps and logic block diagrams disclosed in the aspects of the present disclosure can be implemented or executed. The general-purpose processor can be a micro-processor or the processor can also be any other type of processor, etc. The steps of the method disclosed in the aspects of the present disclosure can be directly embodied as a hardware decoding processor for execution, or a combination of hardware and software modules in the decoding processor for execution. The software module can be located in a storage medium in the field such as random access memory, flash memory, read-only memory, programmable read-only memory or electrically erasable programmable memory, register, etc. The storage medium is located in the memory, and the processor reads the information in the memory and completes the steps of the above method in combination with its hardware.

The electronic device can also execute the method of FIG. 1, and realize the functions of the injection attack detection device in the aspects shown in FIGS. 1-3, and the aspects of the present disclosure will not be described in detail herein.

An aspect of the present disclosure also provides a computer program product, which includes a non-transitory computer-readable storage medium storing a computer program, and the computer program is operable to cause a computer to execute some or all of the steps in the injection attack detection method provided in aspects of the present disclosure.

Of course, in addition to software implementation methods, the electronic device of the present disclosure does not exclude other implementation methods, such as logic devices or a combination of software and hardware, etc. That is to say, the execution subject of the following processing flow is not limited to each logic unit but can also be hardware or logic devices.

The aspect of the present disclosure further proposes a computer-readable storage medium, such as a non-transitory computer-readable medium, which stores one or more programs, and the one or more programs include instructions. When the instructions are executed by a portable electronic device including multiple disclosure programs, the portable electronic device can execute the method of the aspect shown in FIG. 1. In an example, the instructions cause a processor to perform the following operations:
Obtain a video to be detected that illuminates the target face with light.
Perform grayscale transformation on a video frame of the video to be detected to obtain a first grayscale value of the video frame.
Convert the light value label of the video frame into a gray value to obtain a second gray value of the video frame
Based on the first grayscale value and the second grayscale value, determine whether the video to be detected is subjected to an injection attack.

In short, the above description is only an aspect of the present disclosure and is not intended to limit the protection scope of the present disclosure. Any modification, equivalent replacement, improvement, etc. made within the spirit and principle of the present disclosure shall be included in the protection scope of the present disclosure.

The systems, devices, modules or units described in the above aspects may be implemented by computer chips or entities, or by products with certain functions. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

Computer readable media include permanent and non-permanent, removable and non-removable media that can be implemented by any method or technology to store information. Information can be computer readable instructions, data structures, program modules or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital versatile disk (DVD) or other optical storage, magnetic cassettes, magnetic disk storage or other magnetic storage devices or any other non-transmission media that can be used to store information that can be accessed by a computing device. As defined herein, computer readable media does not include temporary computer readable media (transitory media), such as modulated data signals and carrier waves.

It should also be noted that the terms “include,” “comprises,” or any other variations thereof are intended to cover non-exclusive inclusion, so that a process, method, commodity or device including a series of elements includes not only those elements, but also other elements not explicitly listed, or also includes elements inherent to such process, method, commodity or device. In the absence of more restrictions, the elements defined by the sentence “comprises a . . . ” do not exclude the existence of other identical elements in the process, method, commodity or device including the elements.

Each aspect in this specification is described in a progressive manner, and the same or similar parts between the aspects can be referred to each other, and each aspect focuses on the differences from other aspects. In particular, for the system aspect, since it is similar to the method aspect, the description is relatively simple, and the relevant parts can be implemented based on the description of the method aspect.

What is claimed is:

1. A method for detecting an injection attack, the method comprising:
obtaining a video that includes a plurality of video frames of a target face that is illuminated according to a plurality of light values;
performing a grayscale transformation on a video frame of the video to obtain a first grayscale value of the video frame;
converting a light value of the plurality of light values to obtain a second grayscale value corresponding to a light attribute applied in the video frame; and
determining whether the video is subjected to the injection attack based on the first grayscale value and the second grayscale value.

2. The method according to claim 1, wherein the performing the grayscale transformation further comprises:
determining a key facial area in the video frame that satisfies a preset pixel distribution condition based on pixel values in the video frame;
performing the grayscale transformation on the key facial area to obtain a first grayscale image; and
obtaining the first grayscale value based on a mean value of the first grayscale image.

3. The method according to claim 1, wherein the performing the grayscale transformation further comprises:
based on a light illumination direction on the target face, determining an imaging shadow area of the target face in the video frame;
performing the grayscale transformation on the imaging shadow area to obtain a second grayscale image; and
obtaining the first grayscale value based on a mean value of the second grayscale image.

4. The method according to claim 1, wherein the determining whether the video is subjected to the injection attack further comprises:
generating a first grayscale value sequence of the video that includes the first grayscale value;
generating a second grayscale value sequence of the video that includes the second grayscale value;
performing a correlation analysis on the first grayscale value sequence and the second grayscale value sequence to obtain a first coefficient; and
when the first coefficient is less than a preset coefficient, determining the video is subjected to the injection attack.

5. The method according to claim 4, wherein the performing the correlation analysis further comprises:
obtaining an interval duration between an acquisition time of the video and a generation time of a light that illuminates the target face;
based on the interval duration, aligning the first grayscale value sequence and the second grayscale value sequence; and
performing the correlation analysis on the first grayscale value sequence and the second grayscale value sequence based on the aligned first grayscale value sequence and second grayscale value sequence to obtain the first coefficient.

6. The method according claim 1, further comprising:
obtaining a sequence of target RGB values of a light that illuminates the target face; and
controlling the light to illuminate the target face based on the sequence of target RGB values.

7. The method according to claim 6, wherein the obtaining the sequence comprises:
selecting a maximum RGB value and a minimum RGB value, and selecting at least one RGB value in between the maximum RGB value and the minimum RGB value, the R, the G, and the B components being equal values; and
obtaining the sequence of target RGB values based on a combination of the maximum RGB value, the minimum RGB value, and the at least one RGB value.

8. The method according to claim 6, further comprising:
obtaining a non-color attribute sequence of at least one of brightness values or exposure times; and
based on the sequence of target RGB values and the non-color attribute sequence, controlling the light to illuminate the target face.

9. An apparatus of detecting an injection attack, the apparatus comprising:
processing circuitry configured to:
obtain a video that includes a plurality of video frames of a target face that is illuminated according to a plurality of light values;
perform a grayscale transformation on a video frame of the video to obtain a first grayscale value of the video frame;
convert a light value of the plurality of light values to obtain a second grayscale value corresponding to a light attribute applied in the video frame; and
determine whether the video is subjected to the injection attack based on the first grayscale value and the second grayscale value.

10. The apparatus according to claim 9, wherein the processing circuitry is configured to:
based on a light illumination direction on the target face, determine an imaging shadow area of the target face in the video frame;
perform the grayscale transformation on the imaging shadow area to obtain a second grayscale image; and
obtain the first grayscale value based on a mean value of the second grayscale image.

11. The apparatus according to claim 9, wherein the processing circuitry is configured to:
generate a first grayscale value sequence of the video that includes the first grayscale value;
generate a second grayscale value sequence of the video that includes the second grayscale value;
perform a correlation analysis on the first grayscale value sequence and the second grayscale value sequence to obtain a first coefficient; and
when the first coefficient is less than a preset coefficient, determine the video is subjected to the injection attack.

12. The apparatus according to claim 11, wherein the processing circuitry is configured to:
obtain an interval duration between an acquisition time of the video and a generation time of a light that illuminates the target face;
based on the interval duration, align the first grayscale value sequence and the second grayscale value sequence; and
perform the correlation analysis on the first grayscale value sequence and the second grayscale value sequence based on the aligned the first grayscale value sequence and the second grayscale value sequence to obtain the first coefficient.

13. The apparatus according to claim 9, wherein the processing circuitry is configured to:
obtain a sequence of target RGB values of a light that illuminates the target face; and
control the light to illuminate the target face based on the sequence of target RGB values.

14. The apparatus according to claim 13, wherein the processing circuitry is configured to:
select a maximum RGB value and a minimum RGB value, and select at least one RGB value in between the maximum RGB value and the minimum RGB value, the R, the G, and the B components being equal values; and
obtain the sequence of target RGB values based on a combination of the maximum RGB value, the minimum RGB value, and the at least one RGB value.

15. A non-transitory computer-readable storage medium, storing instructions which when executed by a processor cause the processor to perform:
obtaining a video that includes a plurality of video frames of a target face that is illuminated according to a plurality of light values;
performing a grayscale transformation on a video frame of the video to obtain a first grayscale value of the video frame;
converting a light value of the plurality of light values to obtain a second grayscale value corresponding to a light attribute applied in the video frame; and
determining whether the video is subjected to an injection attack based on the first grayscale value and the second grayscale value.

16. The non-transitory computer-readable storage medium according to claim 15, wherein the performing the grayscale transformation further comprises:
based on a light illumination direction on the target face, determining an imaging shadow area of the target face in the video frame;
performing the grayscale transformation on the imaging shadow area to obtain a second grayscale image; and
obtaining the first grayscale value based on a mean value of the second grayscale image.

17. The non-transitory computer-readable storage medium according to claim 15, wherein the determining whether the video is subjected to the injection attack further comprises:
generating a first grayscale value sequence of the video that includes the first grayscale value;
generating a second grayscale value sequence of the video that includes the second grayscale value;
performing a correlation analysis on the first grayscale value sequence and the second grayscale value sequence to obtain a first coefficient; and
when the first coefficient is less than a preset coefficient, determining the video is subjected to the injection attack.

18. The non-transitory computer-readable storage medium according to claim 17, wherein the performing the correlation analysis further comprises:
obtaining an interval duration between an acquisition time of the video and a generation time of a light that illuminates the target face;
based on the interval duration, aligning the first grayscale value sequence and the second grayscale value sequence; and
performing the correlation analysis on the first grayscale value sequence and the second grayscale value sequence based on the aligned first grayscale value sequence and second grayscale value sequence to obtain the first coefficient.

19. The non-transitory computer-readable storage medium according to claim 15, wherein the instructions when executed by the processor further cause the processor to perform:
obtaining a sequence of target RGB values of a light that illuminates the target face; and
controlling the light to illuminate the target face based on the sequence of target RGB values.

20. The non-transitory computer-readable storage medium according to claim 19, wherein the obtaining the sequence further comprises:
selecting a maximum RGB value and a minimum RGB value, and selecting at least one RGB value in between the maximum RGB value and the minimum RGB value, the R, the G, and the B components being equal values; and
obtaining the sequence of target RGB values based on a combination of the maximum RGB value, the minimum RGB value, and the at least one RGB value.
